(19) United States
(12) Patent Application Publication
(10) Pub. No.: US 2026/0243644 A1
(43) Pub. Date: Aug. 20, 2026

(54) IMPACT-SLIDING COMPOSITE FRETTING CORROSION TESTING MACHINE SUITABLE FOR HIGH-TEMPERATURE LEAD-BISMUTH ENVIRONMENT

(71) Applicant: Tianjin University, Tianjin (CN)

(72) Inventors: Guorui ZHU, Tianjin (CN); Hui CHEN, Tianjin (CN); Wei TAN, Tianjin (CN)

(73) Assignee: Tianjin University, Tianjin (CN)

(21) Appl. No.: 19/066,214

(22) Filed: Feb. 28, 2025

(30) Foreign Application Priority Data
Feb. 20, 2025 (CN) 202510191581.X

(51) Int. Cl. G01N 3/56; G01N 17/00

(52) U.S. Cl. CPC G01N 3/567; G01N 17/002; G01N 2203/0098; G01N 2203/0226; G01N 2203/024

(57) ABSTRACT

An impact-sliding composite fretting corrosion testing machine suitable for a high-temperature lead-bismuth environment includes a test bench, a lead-bismuth pipeline, a test kettle, a melting kettle, an excitation system, and a gas circuit control system. The lead-bismuth pipeline is connected to the bottom of the test kettle and the bottom of the melting kettle respectively. A clamping component is set inside the test kettle. The excitation system includes a signal generator, the first power amplifier, the second power amplifier, the first exciter, the second exciter and an excitation fixture. The clamping component includes an upper support plate, a plate sample fixture, a pipe sample, a pipe sample fixture, a cantilever rod, a cantilever rod fixture, a lower support plate, a rotating block, and a movable pin shaft. The impact-sliding composite fretting corrosion testing machine solves the problem that the fretting corrosion behavior cannot be fully studied.

### CROSS REFERENCE TO THE RELATED APPLICATIONS

This application is based upon and claims priority to Chinese Patent Application No. 202510191581.X, filed on Feb. 20, 2025, the entire contents of which are incorporated herein by reference.

### TECHNICAL FIELD

The invention relates to the field of fretting test technology in high-temperature lead-bismuth environment, especially to an impact-sliding composite fretting corrosion testing machine suitable for a high-temperature lead-bismuth environment.

### BACKGROUND

As one of the important candidate reactor types in the new generation nuclear energy system, lead-cooled fast reactor uses lead or lead-bismuth alloy as coolant, which has high density, good thermal conductivity, and wide operating temperature range, and can effectively improve the efficiency and safety of the reactor. However, the strong corrosion of lead-bismuth coolants poses a serious challenge to structural materials. Under the condition of high temperatures and high flow rates, the chemical reaction between the coolant and the structural material will lead to dissolution and corrosion of the metal surface, which will affect the integrity and durability of the structural material. At the same time, the flow of lead-bismuth coolant causes fretting wear between some components and supporting parts, this type of wear usually produces relative displacements in micron-level on the contact surface, and the damaged areas are small and the destructive force is strong, which seriously threatens the safe operation of nuclear power. This wear is further accelerated based on lead-bismuth corrosion, so that the surface of the material is not only affected by chemical corrosion, but also by the superposition of physical wear. To ensure the long-term stable operation of the system and prolong the service life of the material, the dual factors of corrosion and wear should be considered in the design and use of a lead-cooled fast reactor. Therefore, it is of great significance for the development of lead-cooled fast reactors to carry out research on the interaction mechanism between lead-bismuth corrosion and fretting wear, and to develop materials and protection methods that can cope with this complex environment.

At present, the experimental methods used at home and abroad for components prone to fretting wear and fretting corrosion in nuclear reactors mainly focus on the wear mode of tangential slip, and most of the research environments are for water environment or air environment, however, the combined motion of impact and slip in actual working conditions shows a certain degree of randomness in both direction and speed, making it difficult for existing equipment to effectively simulate the fretting wear and corrosion behavior in the real lead-bismuth environment. In order to meet the above experimental requirements, it is urgent to develop a high-temperature fretting corrosion experimental device with a random impact-sliding mode.

### SUMMARY

The purpose of the invention is to provide an impact-sliding composite fretting corrosion testing machine suitable for a high-temperature lead-bismuth environment, and to solve the problem that the fretting corrosion behavior cannot be fully studied because the existing experimental equipment is difficult to perform the fretting corrosion test under the impact-sliding composite motion mode in the lead-bismuth environment.

In order to achieve the above purpose, the invention provides an impact-sliding composite fretting corrosion testing machine suitable for the high-temperature lead-bismuth environment, including a test bench, a lead-bismuth pipeline, a test kettle, a melting kettle, an excitation system and a gas circuit control system, the lead-bismuth pipeline, test kettle, melting kettle, excitation system and gas circuit control system are respectively located on the test bench, the lead-bismuth pipeline is located at a bottom of the test bench, and is connected to the bottom of the test kettle and the bottom of the melting kettle respectively, an interior of the test kettle is equipped with a clamping component, and the test kettle is welded with four large sleeves at an external interval of 90°, four corrugated pipe pull rods A, B, C and D are respectively arranged at an end of the four large sleeves away from the test kettle, the corrugated pipe pull rod includes a pull rod sleeve, a corrugated pipe and a pull rod, the excitation system includes a signal generator, a first power amplifier, a second power amplifier, a first exciter, a second exciter and an excitation fixture, the first exciter and the second exciter are equipped with excitation rods, the clamping component includes an upper support plate, a plate sample fixture, pipe sample, a pipe sample fixture, a cantilever rod, a cantilever rod fixture, a lower support plate, a rotating block and a movable pin shaft.

Preferably, the corrugated pipe is arranged in the pull rod sleeve, and the pull rod passes through the corrugated pipe, one end of the corrugated pipe is welded on an inner end surface of the pull rod sleeve, and the other end is welded on the pull rod, brass gaskets are installed between the pull rod sleeve and the large sleeve, and the pull rod sleeve and the large sleeve are closely connected by bolts.

Preferably, one end of each of two adjacent corrugated pipe pull rods A and B away from the test kettle is equipped with small sleeves, and a displacement sensor is installed inside the small sleeve, one end of each of two adjacent corrugated pipe pull rods C and D away from the test kettle is sequentially equipped with an exciter end bearing fitting, a force sensor, and a connection frame, a center position of an end of the connection frame away from the force sensor is provided with a long hole, and the connection frame is connected to the excitation rods through the long hole.

Preferably, an outer wall of the test kettle is provided with a test kettle heating insulation layer, the test kettle heating insulation layer is embedded with a resistance wire, and an outer side of the melting kettle is provided with a melting kettle heating insulation layer.

Preferably, six bolt holes are distributed on an inner diameter wall of the lower support plate, and the lower support plate is fixed at the bottom of the test kettle by using bolts through the bolt holes.

Preferably, the cantilever rod fixture is installed in a middle of the lower support plate, and a threaded hole is set at a center of the cantilever rod fixture, the cantilever rod is connected to the cantilever rod fixture through the threaded hole.

Preferably, a threaded hole is arranged in a middle of the cantilever rod, and a through hole is opened in a center of a pipe sample fixture and the pipe sample, the pipe sample fixture is placed in the pipe sample and matched with an axis of the cantilever rod, and the pipe sample and the pipe sample fixture are fixed on the cantilever rod by a cylindrical head screw via the threaded hole.

Preferably, an upper support plate structure is the same as a lower support plate structure, and the bolt is fixed in a middle position of the test kettle.

Preferably, the whole plate sample fixture is U-shaped, including a rotating block, a plate sample clamp, and a plate sample, a pin hole is arranged on both sides of the middle of the plate sample clamp, and the rotating block is connected to the plate sample clamp through the movable pin shaft, the plate sample is installed on the rotating block of the plate sample fixture.

Preferably, the excitation fixture is installed on the upper end of the cantilever rod, grooves are set on both sides of the excitation fixture, one end of the pull rod in the corrugated pipe pull rod is connected to the excitation fixture through a high-temperature bearing component, a signal of the signal generator is transmitted to the first exciter and the second exciter respectively through the first power amplifier and the second power amplifier.

The invention adopts the advantages and beneficial effects of the above-mentioned impact-sliding composite fretting corrosion testing machine suitable for high-temperature lead-bismuth environment.

1. The invention uses the exciter as a power source, and designs a set of pipe and plate sample clamping components that can perform impact-sliding composite motion, the cantilever rod and the surrounding components are independent of each other, which improves the flexibility of the clamping component and the accuracy of the contact force and motion displacement measurement between the pipe and plate samples.

2. The invention vertically distributes two exciters, and simultaneously applies mutually perpendicular forces to the cantilever rod, thereby the cantilever rod has an impact-sliding composite motion, and ensures that the composite motion has certain random characteristics in the motion direction and motion rate, by installing a high-temperature bearing component at the end of the corrugated pipe pull rod connecting the displacement sensor, and making the high-temperature bearing component fit with the excitation fixture, the displacement decomposition of the composite motion in the horizontal and vertical directions is realized.

3. The test system of the invention is composed of a test kettle, a heating insulation layer, a corrugated pipe pull rod, and other parts, the corrugated pipe pull rod is rigidly connected with the exciter to reduce the motion error, and the lead-bismuth pipeline controls the transmission of lead-bismuth alloy, the heating insulation layer of the test kettle and the melting kettle can provide heating, insulation and related temperature control at the same time.

The following is a further detailed description of the technical scheme of the invention through drawings and an embodiment.

### BRIEF DESCRIPTION OF THE DRAWINGS

FIG. 1 is an overall structural diagram of the impact-sliding composite fretting corrosion testing machine suitable for the high-temperature lead-bismuth environment;

FIG. 2 is a diagram of the test kettle in the impact-sliding composite fretting corrosion testing machine suitable for the high-temperature lead-bismuth environment;

FIG. 3 is a section view of the test kettle in the impact-sliding composite fretting corrosion testing machine suitable for the high-temperature lead-bismuth environment;

FIG. 4 is a schematic diagram of the combination of the clamping component and the exciter in the impact-sliding composite fretting corrosion testing machine suitable for the high-temperature lead-bismuth environment;

FIG. 5 is a schematic diagram of the clamping component in the impact-sliding composite fretting corrosion testing machine suitable for the high-temperature lead-bismuth environment;

FIG. 6 is an explosion diagram of the pipe sample and pipe sample fixture in an impact-sliding composite fretting corrosion testing machine suitable for the high-temperature lead-bismuth environment.

### GRAPHIC DESCRIPTION

1, test bench; 2, lead-bismuth pipeline; 3, melting kettle; 4, signal generator; 5, the first power amplifier; 6, the second exciter; 7, the second power amplifier; 8, gas circuit control system; 9, the first exciter; 10, test kettle; 11, connection frame; 12, exciter end bearing fitting; 13, corrugated pipe pull rod A; 14, displacement sensor; 15, small sleeve; 16, large sleeve; 17, force sensor; 18, brass gasket; 19, pull rod bushing; 20, corrugated pipe; 21, pull rod; 22, test kettle heating insulation layer; 23, excitation rod; 24, clamping component; 25, high-temperature bearing component; 26, cantilever rod; 27, excitation fixture; 28, rotating block; 29, movable pin shaft; 30, plate sample fixture; 31, cantilever rod fixture; 32, pipe sample; 33, pipe sample fixture; 34, upper support plate; 35, lower support plate; 36, corrugated pipe pull rod B; 37, corrugated pipe pull rod C; 38, corrugated pipe pull rod D.

### DETAILED DESCRIPTION OF THE EMBODIMENTS

The following is a further explanation of the technical scheme of the invention through drawings and an embodiment.

Unless otherwise defined, the technical terms or scientific terms used in the invention should be understood by people with general skills in the field to which the invention belongs. The words first, second, and the like used in this invention do not represent any order, quantity, or importance, but are only used to distinguish different components. Similar words such as include or comprise mean that the elements or objects appearing before the word cover the elements or objects listed after the word and their equivalents, without excluding other elements or objects. Similar words such as connected or connecting are not limited to physical or mechanical connections, but can include electrical connections, whether direct or indirect. Up, down, left, right, etc. are only used to represent the relative positional relationship, when the absolute position of the described object changes, the relative positional relationship may also change accordingly.

### Example 1

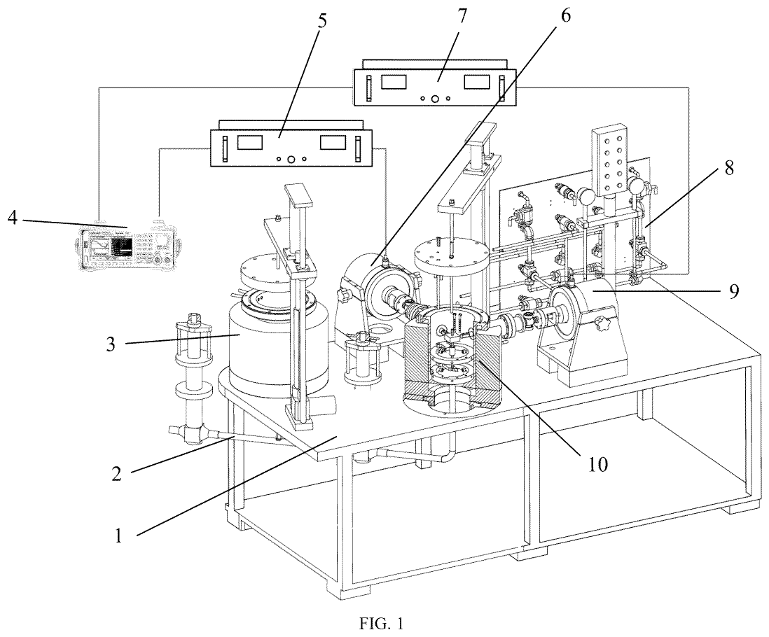

As shown in FIG. 1, an impact-sliding composite fretting corrosion testing machine suitable for high-temperature lead-bismuth environment, including the test bench 1, the lead-bismuth pipeline 2, the test kettle 10, the melting kettle 3, the excitation system, the gas circuit control system 8. The lead-bismuth pipeline 2, the test kettle 10, the melting kettle 3, the excitation system, and the gas circuit control system 8 are respectively located on the test bench 1. The outer wall of the test kettle 10 is equipped with a test kettle heating insulation layer 22, the test kettle heating insulation layer 22 is embedded with a resistance wire, and the outer wall of the melting kettle 3 is equipped with a melting kettle 3 heating insulation layer.

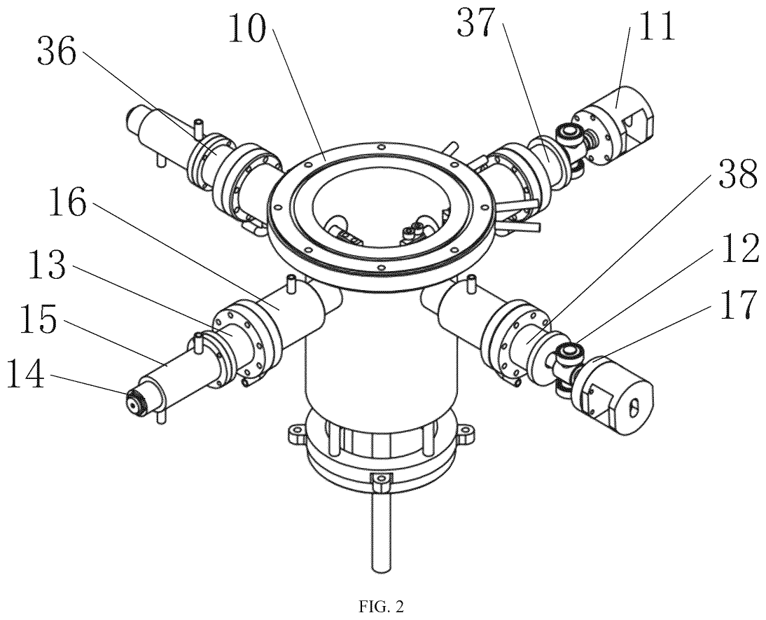

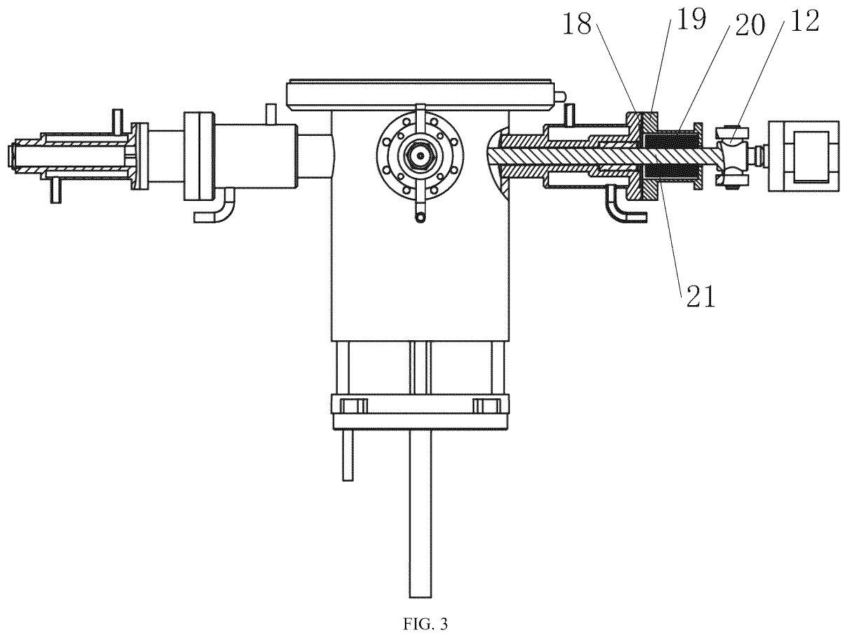

The lead-bismuth pipeline 2 is located at the bottom of the test bench 1 and is connected to the bottom of the test kettle 10 and the melting kettle 3 respectively. The outer side of the lead-bismuth pipeline 2 is wrapped with a heating resistance wire to provide heating, insulation, and related temperature control. As shown in FIG. 2, the outer side interval of the test kettle 10 is welded with four large sleeves 16 with an interval of 90°, the corrugated pipe pull rod A 13, corrugated pipe pull rod B 36, corrugated pipe pull rod C 37 and corrugated pipe pull rod D 38 are in bolted connections with four large sleeves 16, respectively, the large sleeve 16 can be filled with cooling water to provide cooling protection for the corrugated pipe pull rod. As shown in FIG. 3, the corrugated pipe pull rod includes the pull rod sleeve 19, the corrugated pipe 20, and the pull rod 21, the corrugated pipe 20 is arranged in the pull rod sleeve 19, and the pull rod 21 passes through the corrugated pipe 20, one end of the corrugated pipe 20 is welded on the inner end surface of the pull rod sleeve 19, and the other end is welded on the pull rod 21, the brass gasket 18 is installed between the pull rod sleeve 19 and the large sleeve 16, and the pull rod sleeve 19 and the large sleeve 16 are tightly connected by bolts.

The two adjacent corrugated pipe pull rod A 13 and corrugated pipe pull rod B 36 which are not directly connected to the exciter are equipped with a small sleeve 15 at one end away from the test kettle 10. The other two adjacent corrugated pipe pull rod C 37 and corrugated pipe pull rod D 38 are arranged at one end away from the test kettle 10, which are respectively equipped with an exciter end bearing fitting 12, a force sensor 17 and a connection frame 11, the inner side of the small sleeve 15 is equipped with a displacement sensor 14, the exciter end bearing fitting 12 is equipped with a force sensor 17 at one end away from the corrugated pipe pull rod, and the force sensor 17 is equipped with a connection frame 11 at one end away from the exciter end bearing fitting 12, the center of the connection frame 11 away from the end of the force sensor 17 with a long hole. The connection frame 11 is connected to the excitation rods 23 on the first exciter 9 and the second exciter 6 respectively through the long hole, the first exciter 9 and the second exciter 6 are fixed on the base, and the installation height ensures that the excitation rod 23 can be in a bolted connection with the connection frame 11 in a horizontal state.

When the test kettle 10 is heated, the connection between the connection frame 11 and the first exciter 9 and the second exciter 6 is loosened, which provides space for the thermal deformation of the test kettle 10; after the temperature is stable, the connection frame 11 is connected with the first exciter 9 and the second exciter 6 for subsequent tests; after the temperature drops, the connection between the connection frame 11 and the first exciter 9 and the second exciter 6 is loosened again, which provides the deformation space for the cooling and contraction of the test kettle 10, and avoids the excessive tension and pressure on the first exciter 9 and the second exciter 6 caused by the thermal expansion and contraction of the test kettle 10.

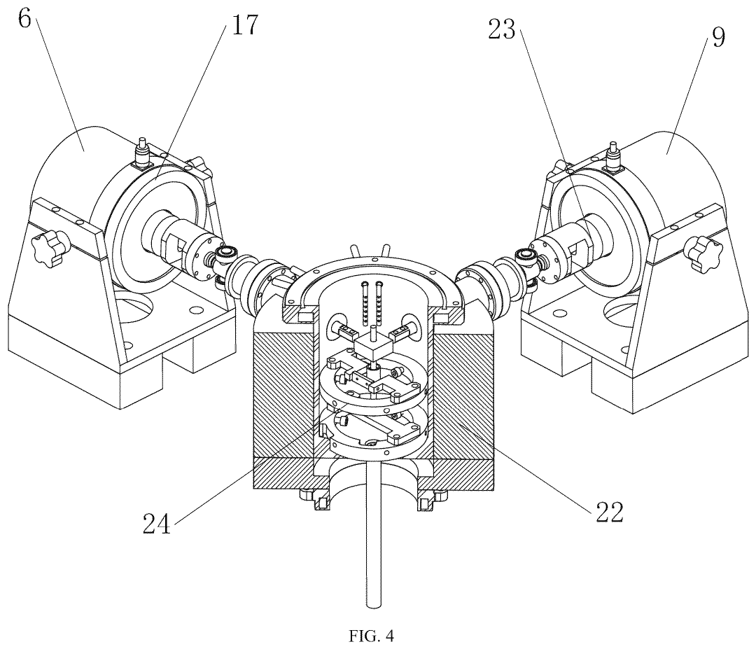

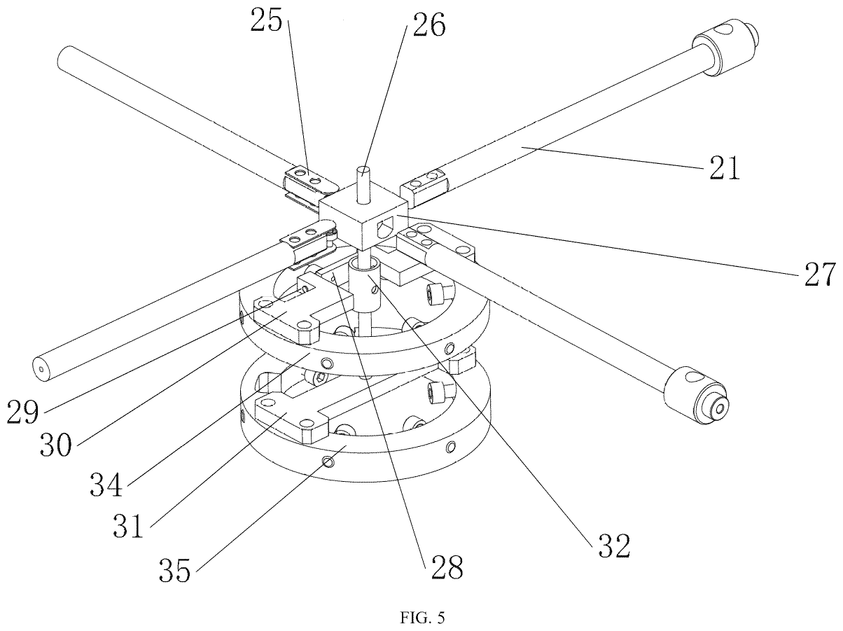

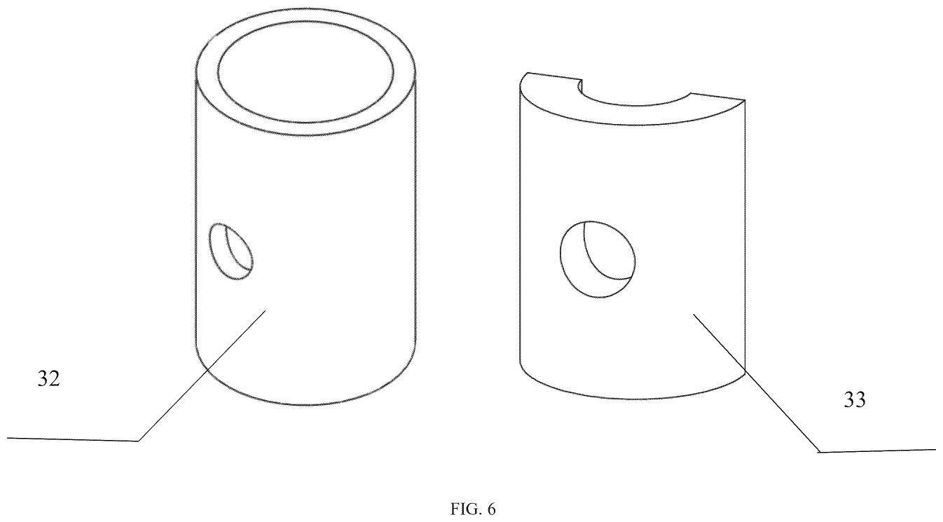

As shown in FIG. 4 and FIG. 5, a clamping component 24 is set inside the test kettle 10, the clamping component 24 includes the upper support plate 34, the plate sample fixture 30, the pipe sample 32, the pipe sample fixture 33, the cantilever rod 26, the cantilever rod fixture 31, the lower support plate 35, the rotating block 28, and the movable pin shaft 29. Six bolt holes are distributed on the inner diameter wall of the lower support plate 35, and the lower support plate 35 is fixed at the bottom of the test kettle 10 by using bolts through the bolt holes. The cantilever rod fixture 31 is installed in the middle of the lower support plate 35, a thread hole is set at the center of the cantilever rod fixture 31, and the cantilever rod 26 is connected to the cantilever rod fixture 31 thread through the thread hole. As shown in FIG. 6, a threaded hole is opened in the middle of the cantilever rod 26, and a through hole is opened in the center of the pipe sample fixture 33 and the pipe sample 32. The pipe sample fixture 33 is placed inside the pipe sample 32, which is matched with the axis of the cantilever rod 26, and the pipe sample 32 and the pipe sample fixture 33 are fixed on the cantilever rod 26 by a cylindrical head screw. The structure of the upper support plate 34 is the same as that of the lower support plate 35, which is fixed by bolts in the middle of the test kettle 10. The plate sample fixture 30 is U-shaped as a whole, including the rotating block 28, the plate sample clamp, and the plate sample, pin holes are set on both sides of the plate sample clamp, and the rotating block 28 is connected to the plate sample clamp through the movable pin shaft 29, the plate sample is installed on the rotating block 28 of the plate sample fixture 30, which is kept at the same height with the position of the pipe sample 32, so that the plate sample and the pipe sample 32 can be in line contact.

The excitation system includes the signal generator 4, the first power amplifier 5, the second power amplifier 7, the first exciter 9, the second exciter 6, the excitation fixture 27, the inner sides of first exciter 9 and second exciter 6 is equipped with excitation rod 23, as shown in FIG. 5, the excitation fixture 27 is installed on the upper end of the cantilever rod 26, the side of the excitation fixture 27 corresponds to the sides of the first exciter 9 and the second exciter 6 is set with a groove, two corrugated pipe pull rods 13 near the side of the first exciter 9 and the second exciter 2 are inserted into the groove of the excitation fixture 27 respectively. One end of the pull rod 21 of the corrugated pipe pull rod A 13 and corrugated pipe pull rod B connected with the small sleeve 15 is connected with the excitation fixture 27 through the high-temperature bearing component 25. The high-temperature bearing component 25 is installed at the end of the pull rod 21 in the corrugated pipe pull rod A and the corrugated pipe pull rod B (this end is within the test kettle 10). The end runs through the side wall of the test kettle 10 and is connected to the side of the excitation fixture 27. The side of the excitation fixture 27 is divided into a flat surface and a groove surface, the high-temperature bearing component 25 is closely attached to the flat surface of the excitation fixture 27.

One end of the pull rod 21 in the corrugated pipe pull rod A 13, the corrugated pipe pull rod B 36, the corrugated pipe pull rod C 37, and the corrugated pipe pull rod D 38 is located in the test kettle, and the other end is located outside the test kettle.

When the first exciter 9 and the second exciter 6 move, the force in two vertical directions is transferred to the cantilever rod 26, so as to drive the pipe sample 32 on the cantilever rod 26 to carry out the impact-sliding composite motion. The signal of the signal generator 4 is transmitted to the first exciter 9 and the second exciter 6 by the first power amplifier 5 and the second power amplifier 7 respectively.

The specific excitation signal is output by the signal generator, and the signal is amplified by the power amplifier and input into the exciter, so the exciter transmits different forms of excitation outward. When the fretting wear corrosion experiment is carried out, it is first necessary to connect the connection frame 11 with the exciter by bolt, the force sensors are installed between the connection frame 11 and the corrugated pipe pull rod C 37, and the corrugated pipe pull rod D 38. The ends of the pull rods 21 of the corrugated pipe pull rod C 37 and the corrugated pipe pull rod D 38 near the exciter are inserted into the groove of the excitation fixture 27. The corrugated pipe 20 on the pull rod 21 maintains the maximum compression state to ensure that the pull rod 21 is in close contact with the excitation fixture 27. Since the experimental displacement is within the fretting range, the interference of the small deformation of the corrugated pipes 20 on the accuracy of the force in the experiment can be ignored. When the exciter works, the two vertical forces are transmitted to the cantilever rod 26 through the pull rod 21, so that the cantilever rod 26 drives the pipe sample 32 to produce a composite motion, and a composite motion mode of impact-sliding is shown during the contact process of the pipe and plate samples. There are two pull rods 21 of the corrugated pipe pull rod A 13 and the corrugated pipe pull rod B 36 which are not connected to the exciter. One end of each pull rod 21 is in contact with the displacement sensor 14, and the other end is installed with a high-temperature bearing component 25, the high-temperature bearing component 25 fits the flat surface of the excitation fixture 27, and the corrugated pipe 20 on the pull rod 21 also maintains the maximum compression state. When the cantilever rod 26 undergoes a composite motion, the composite displacement is decomposed into mutually perpendicular displacement components by two high-temperature bearing components 25 and transmitted to the pull rod 21, the displacement sensor 14 at the end detects and obtains the displacement change data in the experiment.

Through the above methods, the impact-sliding composite fretting corrosion experiment under 0-100 N excitation force can be realized, and the contact force and displacement changes in the experimental process can be obtained by the sensor and recorded in the computer for further analysis.

Test bench 1, lead-bismuth pipeline 2, test kettle 10, melting kettle 3, and gas circuit control system 8 all adopt the existing technology.

The fretting corrosion wear testing machine needs to ensure that the internal friction of the testing machine remains stable during the experiment, and the force sensor 17 measures the friction force during the friction process of the sample. Table 1 shows the tangential internal friction data at room temperature and no-load, and Table 2 shows the internal friction data at 350° C. and no-load. From the data in Table 1-Table 2, it can be seen that the difference between the original data and the average value is very small.

TABLE 1
Friction data in the tangential direction
at room temperature and no-load

| | | | | |
|---|---|---|---|---|
| Amplitude μm | 50 | 86 | 130 | 220 |

| | | | | | |
|---|---|---|---|---|---|
| Intrinsic | 1 | 1.74 | 2.02 | 2.14 | 2.95 |
| friction(N) | 2 | 1.84 | 2.02 | 2.17 | 2.92 |
| | 3 | 1.84 | 1.95 | 2.11 | 2.84 |
| | 4 | 1.88 | 1.94 | 2.07 | 2.74 |
| | 5 | 1.85 | 1.93 | 2.03 | 2.7 |
| | 6 | 1.85 | 1.93 | 2.05 | 2.73 |

| | | | | |
|---|---|---|---|---|
| Average value | 1.83 | 1.97 | 2.10 | 2.81 |
| Average deviation | 0.03 | 0.04 | 0.05 | 0.09 |
| value | | | | |

TABLE 2
Friction data in tangential direction at no-load at 350° C.

| | | | | |
|---|---|---|---|---|
| Amplitude μm | 50 | 80 | 100 | 130 |

| | | | | | |
|---|---|---|---|---|---|
| Intrinsic | 1 | 2.33 | 2.9 | 3.28 | 2.98 |
| friction(N) | 2 | 2.38 | 2.92 | 3.37 | 3.09 |
| | 3 | 2.3 | 2.94 | 3.34 | 3.11 |
| | 4 | 2.29 | 2.98 | 3.28 | 3.14 |
| | 5 | 2.39 | 2.95 | 3.3 | 3.02 |
| | 6 | 2.34 | 2.92 | 3.32 | 3.02 |

| | | | | |
|---|---|---|---|---|
| Average value | 2.34 | 2.94 | 3.32 | 3.06 |
| Average deviation | 0.03 | 0.02 | 0.03 | 0.05 |
| value | | | | |

Therefore, the invention uses the above-mentioned impact-sliding composite fretting corrosion testing machine suitable for high-temperature lead-bismuth environment to solve the problem that the fretting corrosion behavior cannot be fully studied because the existing experimental equipment is difficult to perform the fretting corrosion test of the impact-sliding composite motion mode in the lead-bismuth environment.

Finally, it should be explained that the above embodiment is only used to explain the technical scheme of the invention rather than restrict it. Although the invention is described in detail concerning the better embodiment, the ordinary technical personnel in this field should understand that they can still modify or replace the technical scheme of the invention, and these modifications or equivalent substitutions cannot make the modified technical scheme out of the spirit and scope of the technical scheme of the invention.

What is claimed is:

1. An impact-sliding composite fretting corrosion testing machine suitable for a high-temperature lead-bismuth environment, comprising a test bench, a lead-bismuth pipeline, a test kettle, a melting kettle, an excitation system and a gas circuit control system, wherein the lead-bismuth pipeline, the test kettle, the melting kettle, the excitation system and the gas circuit control system are respectively located on the test bench, the lead-bismuth pipeline is located at a bottom of the test bench, and is connected to a bottom of the test kettle and a bottom of the melting kettle respectively, an interior of the test kettle is equipped with a clamping component, the test kettle is welded with four large sleeves at an external interval of 90°, four corrugated pipe pull rods A, B, C and D are respectively arranged at ends of the four large sleeves away from the test kettle, each of the four corrugated pipe pull rods A, B, C and D comprises a pull rod sleeve, a corrugated pipe and a pull rod, the excitation system comprises a signal generator, a first power amplifier, a second power amplifier, a first exciter, a second exciter and an excitation fixture, the first exciter and the second exciter are equipped with excitation rods, and the clamping component comprises an upper support plate, a plate sample fixture, a pipe sample, a pipe sample fixture, a cantilever rod, a cantilever rod fixture, a lower support plate, a rotating block and a movable pin shaft.

2. The impact-sliding composite fretting corrosion testing machine suitable for the high-temperature lead-bismuth environment according to claim 1, wherein the corrugated pipe is arranged in the pull rod sleeve, the pull rod passes through the corrugated pipe, a first end of the corrugated pipe is welded on an inner end surface of the pull rod sleeve, a second end of the corrugated pipe is welded on the pull rod, brass gaskets are installed between the pull rod sleeve and the large sleeve, and the pull rod sleeve and the large sleeve are closely connected by bolts.

3. The impact-sliding composite fretting corrosion testing machine suitable for the high-temperature lead-bismuth environment according to claim 1, wherein ends of two adjacent corrugated pipe pull rods A and B away from the test kettle are respectively equipped with small sleeves, a displacement sensor is installed inside each of the small sleeves, an end of each of two adjacent corrugated pipe pull rods C and D away from the test kettle is sequentially equipped with an exciter end bearing fitting, a force sensor and a connection frame, a center position of an end of the connection frame away from the force sensor is provided with a long hole, and the connection frame is connected to the excitation rods through the long hole.

4. The impact-sliding composite fretting corrosion testing machine suitable for the high-temperature lead-bismuth environment according to claim 1, wherein an outer wall of the test kettle is provided with a test kettle heating insulation layer, the test kettle heating insulation layer is embedded with a resistance wire, and an outer side of the melting kettle is provided with a melting kettle heating insulation layer.

5. The impact-sliding composite fretting corrosion testing machine suitable for the high-temperature lead-bismuth environment according to claim 1, wherein six bolt holes are distributed on an inner diameter wall of the lower support plate, and the lower support plate is fixed at the bottom of the test kettle by using bolts through the six bolt holes.

6. The impact-sliding composite fretting corrosion testing machine suitable for the high-temperature lead-bismuth environment according to claim 1, wherein the cantilever rod fixture is installed in a middle of the lower support plate, and a threaded hole is set at a center of the cantilever rod fixture, and the pipe sample and the pipe sample fixture are fixed on the cantilever rod by a cylindrical head screw via the threaded hole.

7. The impact-sliding composite fretting corrosion testing machine suitable for the high-temperature lead-bismuth environment according to claim 1, wherein a threaded hole is arranged in a middle of the cantilever rod, and a through hole is opened in a center of the pipe sample fixture and the pipe sample, the pipe sample fixture is placed in the pipe sample and matched with an axis of the cantilever rod, and a cylindrical head screw is fixed on the cantilever rod through the threaded hole.

8. The impact-sliding composite fretting corrosion testing machine suitable for the high-temperature lead-bismuth environment according to claim 1, wherein an upper support plate structure is identical to a lower support plate structure, and a bolt is fixed in a middle position of the test kettle.

9. The impact-sliding composite fretting corrosion testing machine suitable for the high-temperature lead-bismuth environment according to claim 1, wherein the plate sample fixture is U-shaped, and comprises the rotating block, a plate sample clamp and a plate sample, a thread hole is arranged on both sides of a middle of the plate sample clamp, the rotating block is connected to the plate sample clamp through a movable pin shaft, and the plate sample is installed on the rotating block of the plate sample fixture.

10. The impact-sliding composite fretting corrosion testing machine suitable for the high-temperature lead-bismuth environment according to claim 1, wherein the excitation fixture is installed on an upper end of the cantilever rod, grooves are set on both sides of the excitation fixture, an end of the pull rod in each of the four corrugated pipe pull rods A, B, C and D is connected to the excitation fixture through a high-temperature bearing component, and a signal of the signal generator is transmitted to the first exciter and the second exciter respectively through the first power amplifier and the second power amplifier.
